(19) United States
(12) Patent Application Publication
(10) Pub. No.: US 2024/0378933 A1
(43) Pub. Date: Nov. 14, 2024

(54) Central Management System and Methods to Manage Facility Entrances

(71) Applicant: SANJEEV VINAYAGAM KUMAR, GERMANTOWN, MD (US)

(72) Inventor: SANJEEV VINAYAGAM KUMAR, GERMANTOWN, MD (US)

(21) Appl. No.: 18/655,271

(22) Filed: May 5, 2024

Related U.S. Application Data
(60) Provisional application No. 63/464,960, filed on May 9, 2023.

(51) Int. Cl. G07C 9/10; G06Q 10/0631; G07C 9/25; G10L 15/22

(52) U.S. Cl. CPC G07C 9/10; G06Q 10/06311; G07C 9/25; G10L 15/22

(57) ABSTRACT

A Central Management System (CMS) and methods to manage facility entrances in different locations remotely. It is a sophisticated solution designed to enhance security, privacy, and health by managing access to various facilities, such as corporate offices, healthcare institutions, and secure areas. The CMS allows remote access to entrances without physical contact, leveraging AI and IoT technologies to electronic remote access control transmitters or manual operation. The system's core feature is tracking entrance activities, providing valuable insights for security surveillance, traffic flow analysis, human resource management, and employee attendance monitoring. By integrating various methods, such as, video surveillance, access control systems, RFID tracking, and manual oversight, the CMS ensures a comprehensive approach to facility entrance management, optimizing operational efficiency and safety protocols while ensuring regulatory compliance.

This application claims the priority date of U.S. Provisional Patent Application No. 63/464,960, filed on May 9, 2023, the entire content of which is incorporated herein by reference.

### BACKGROUND OF THE INVENTION

The present invention is in the field of Central Management System (CMS) and methods for managing facility entrances activities in multiple locations, including entrance opening with scheduled office hours. It is known to allow people in and out of entrances remotely without the need to touch the door physically for privacy, security, and health. This solution can be used for existing swinging or sliding doors in areas, such as reception areas, executive offices, conference rooms, security desks, health clinics, and nurse stations, etc., using electronic remote access control transmitter or manually operated.

One important feature of a CMS is to provide tracking of facility entrance activities. Tracking facility entrance activities typically involve monitoring and recording the movement of people and vehicles as they enter and exit a particular facility. This can be useful for a variety of purposes, including security monitoring, traffic flow and human resource analysis, and employee attendance tracking.

There are several methods that can be used to track facility entrance activities, including:
1. Video surveillance: Cameras can be placed at the entrance of a facility to record the movement of people and vehicles in and out of the facility.
2. Access control systems: Access control systems can be used to monitor who enters and exits a facility, as well as the times they do so. These systems typically require some form of identification, such as a key card or biometric data, to gain entry and exit.
3. RFID tracking: Radio-Frequency Identification (RFID) tags can be attached to personnel or vehicles to track their movement in and out of a facility. This technology uses radio waves to communicate with sensors, which can be placed at various locations, such as the entrances of a facility.
4. Manual tracking: Manual tracking involves having personnel physically stationed at the entrances of a facility to record the movement of people and vehicles as they enter and exit the facility.

The type of tracking method used will depend on the specific needs and goals of the facility. It is important to ensure that any tracking activities are conducted in compliance with applicable privacy and data protection laws and regulations.

Electronic remote access control is no longer reserved for just the perimeter of a facility. Innovative solutions, such as Intelligent Wi-Fi, real-time wireless, and Internet of Thing (IoT), make it easier to extend remote access control to more entrances and more applications. These technologies improve safety, security, health, efficiency, productivity, and provide valuable data and insights of entrance activities. However, these technologies are usually complicated, expensive and resource intensive to implement than having an employee physically located at the facility and manually managing the management system. The present invention aims to resolve these restrictions of a remote electronic central management system by providing a simple and inexpensive CMS and methods to remotely monitor facility entrances, and to provide valuable data for various analysis.

### SUMMARY OF THE INVENTION

The CMS for monitoring facility entrances of the present invention is a sophisticated solution designed to enhance security, privacy, and health by managing access to various facilities. This system is particularly relevant in the context of multiple locations, such as corporate offices, healthcare institutions and secure areas, where controlled access is crucial. The CMS leverages technology to allow remote access to entrances without physical contact, accommodating both swinging and sliding doors. This is achieved through electronic remote access control transmitters or manual operation, providing flexibility in application.

The monitoring of entrance activities is a core feature of the CMS, offering valuable insights into the movement of people and vehicles. This monitoring is instrumental for security surveillance, analyzing traffic flow, managing human resources, and tracking employee attendance. The data collected through this system can be utilized to optimize operational efficiency, enhance safety protocols, and ensure compliance with regulatory standards.

Various methods are employed within the CMS to monitor entrance activities effectively. Video surveillance is a common approach, utilizing cameras to capture real-time footage of entry and exit points. Access control systems offer a more personalized level of security, requiring identification such as key cards or biometric data to authorize entry. RFID tracking provides a seamless method of monitoring movements using radio waves to detect tags attached to individuals or vehicles. Lastly, manual tracking serves as a traditional yet reliable method, involving personnel to oversee and record access.

The integration of these methods within a CMS framework ensures a comprehensive and multi-layered approach to facility entrance management. By combining technological advancements with robust monitoring mechanisms, the CMS of the present invention provides a dynamic and adaptable solution to meet the evolving demands of facility security and access control. The system's design reflects a deep understanding of the complexities associated with managing multiple entrances across various locations, highlighting its potential to revolutionize the way facilities approach entrance monitoring and control. The CMS of the present invention stands as a testament to innovation in the field of security and facility management, promising enhanced operational integrity and peace of mind for stakeholders.

One embodiment of the present invention is to provide a system and methods to gain access to a facility remotely, using various security measures.

Another embodiment of the present invention is to use an inexpensive security system, involves the use of identity verification method to validate assigned personnels.

Another embodiment of the present invention is to utilize an efficient backup system in case of failures in timely opening facilities due to installed hardware or assigned personnel.

Another embodiment of the present invention is to provide detailed reports of daily activities in entrance access of facilities in various locations.

### BRIEF DESCRIPTION OF THE DRAWINGS

FIG. 1 illustrates a flowchart of the Central Management System (CMS).

FIG. 2 illustrates the Interactive Voice Response (IVR) system in the CMS.

FIG. 3 illustrates an example of the procedures of a Communication System (CS) failure backup module.

FIG. 4 illustrates an example of components utilized in a CS failure backup module.

### DETAILED DESCRIPTION OF THE PREFERRED EMBODIMENT

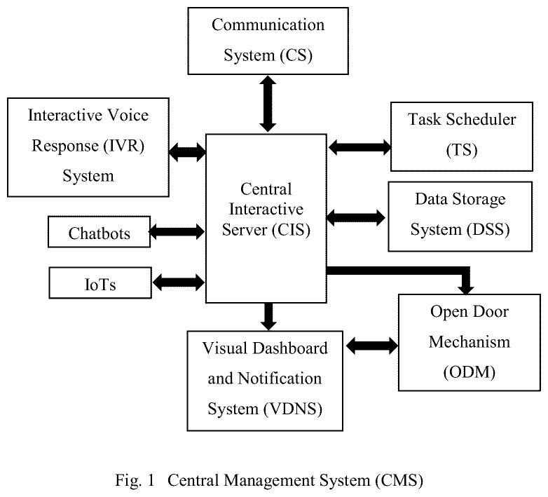

Referring to FIG. 1 of the invention, designated employees in different facility locations are communicating with the Central Management System (CMS.) Each facility is equipped with a secure device having a unique facility ID code number. The designated employee who opens the door in each facility utilizes a secured Communication System (CS), together with an assigned employee ID to check-in to the CMS through a Central Interactive Server (CIS). The CIS within the CMS includes a cellular networks, a Wi-Fi network, a Bluetooth network, a Satellite network, or an Ethernet network. The CMS further includes an Interactive Voice Response (IVR) System, an Open Door Mechanism (ODM), a Data Storage System (DSS) having whitelists stored, a Task Scheduler (TS) for assigning employee tasks, and a Visual Dashboard and Notification System (VDNS). Nowadays, we carry access cards, ID badges or smartphones with built-in ID codes in addition to physical keys, to gain entry to secured areas. Access control systems can also be used to restrict access to workstations, file rooms housing sensitive data, printers, and entry doors. The facility ID code number could be altered periodically for improved security.

The CMS of the present invention includes the following requirements:
1. Scalability: The system should be able to handle an increasing number of monitored facilities without a decrease in performance.
2. Reliability: The system should have a high level of uptime and provide accurate and consistent data on facility entrance activities.
3. Real-time monitoring: The system should provide real-time data on the movement of people and vehicles in and out of monitored facilities on a desktop PC or big-screen monitor.
4. Improving customer service: AI-powered Chatbots can provide instant customer support, answering questions and resolving issues 24/7.
5. Customizability: The system should allow for customization to meet the specific needs of the organization, such as the ability to set scheduled office hours for entrance opening.
6. Door Opening Mechanism Independent: The door opening mechanism at the facilities could be independent of the CMS.
7. Ease of use: The system should have an intuitive interface that is easy for users to navigate.
8. Alerts and notifications: The system should provide alerts and notifications when certain conditions are met, such as when an unauthorized person attempts to enter a facility or when a threshold is exceeded.
9. Reporting: The system should provide detailed reports on facility entrance activities, including historical data and trends.
10. Integration with CMS: The system should be able to integrate with various systems and methods to manage facility entrance activities. For example, the system should be compatible with video surveillance, access control systems, RFID tracking, Interactive Voice Response (IVR) system, and manual tracking.

Any biometric authentication comprising fingerprints or facial recognition, including Interactive Voice Response (IVR) system using Caller ID as authentication can be used within the CMS of the present invention. IVR system is an automated telephone system that combines pre-recorded messages or text-to-speech technology to engage callers, providing information without a live agent. If the IVR system cannot retrieve the information that the caller is looking for, the programmed menu options can route callers to the appropriate representative for help. By integrating computer and telephony technologies, IVR software can improve call flow and reduce wait times, leading to higher overall customer satisfaction.

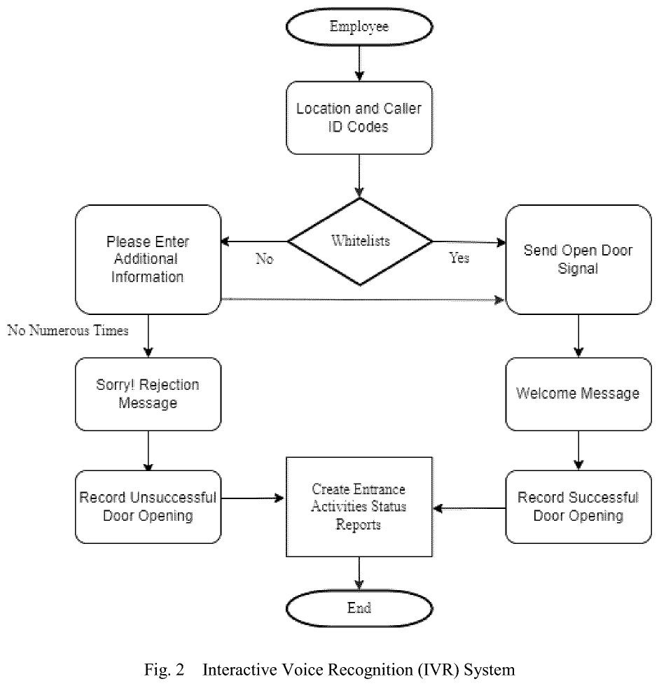

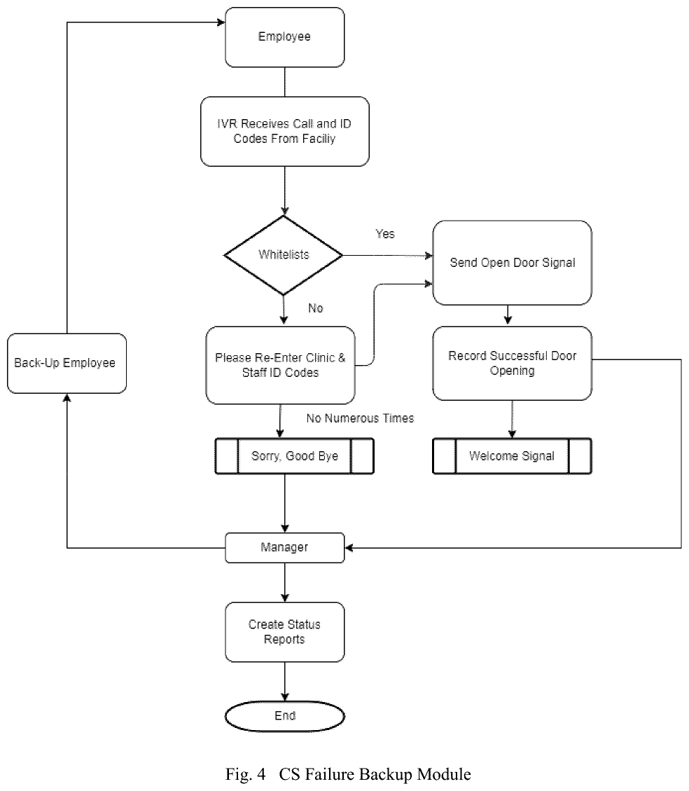

Referring to FIGS. 2 and 4, the IVR system used in the present invention collects the caller's assigned employee ID and the corresponding facility ID code number. Then submits this information to a whitelist or database within a server for identity and location verifications. If the verifications are successful, the server will respond with a welcome message to the designated employee and proceeds to open the entrance of the facility. If the verifications are unsuccessful, the server will respond with an additional information request to the designated employee. Then the designated employee will respond to the request with the appropriate information. The requested information will go through the verification process again. If the requested information is correct, the designated employee will receive a welcome message and the facility entrance will be opened. If the requested information is incorrect, the server will issue a rejection message to the caller and the facility entrance will remain closed. At the same time, the server issues a warning message to a managing supervisor.

The secured device could be a desktop PC, a cell phone, a receptionist's desk phone, or a GPS tracking enabled device at the facility. Managers in different regions monitor the current office opening status through a real time office opening map on a monitor screen or display. As shown in FIG. 4, the managers have the option to get notified automatically for offices not yet open during the corresponding office hours. The managers will initiate a back-up plan and contact backup staff to open those not-yet-opened offices manually or automatically. The managers can also run status reports of facility entrance activities anytime when needed for analysis and insights.

Instead of using a touch tone system, more advanced IVR software enables callers to verbalize their needs on the phone. Then, through speech recognition, IVR system can understand and respond to their inquiries in real-time. Some IVR systems incorporate voice recognition technology to verify the identity of an individual, adding an extra layer of security. This can be helpful for highly sensitive personal information, like social security and phone numbers, checking and savings account information, and lab results from doctor's appointments. IVR systems improve the customer experience by providing a self-service method for customers to access the information that they need without the assistance of customer support. It also reduces the call volume for contact centers, lowering wait times and operational costs for businesses. IVR solutions have been utilized across a variety of industries, including banking, healthcare, education, and retail. Below is an exemplary facility entrance opening situation to illustrate one of the uses of the present invention:

As an example, a designated employee arrives at the entrance of a clinic before the scheduled opening hours. The employee would call the Central Management System (CMS) using a secure communication system (CS). The CS could be located either outdoors of a locked entrance or inside an enclosed area of a locked entrance. The CS is coded with a facility location ID number. The employee would enter an assigned employee ID number when calling the CMS. The CS can be a desk phone, a mobile phone, a PC, or other digital devices.

When the CMS receives the facility ID and employee ID numbers, it will verify the numbers against whitelists stored in databases of a server. If the verification is successful, the CMS would issue a Welcome message and optionally proceed to grant permission to open the facility entrance. On the other hand, if the verification is not successful, the CMS would issue a Rejection message and request for more additional information from the caller. If the additional information is verified successfully, the CMS would issue a Welcome message and proceed to grant permission to open the entrance normally.

If the additional information cannot be verified successfully, the CMS would issue a Rejection message and the entrance opening would be denied. At the same time, the CMS would send an urgent message to an attending manager of that region, informing them of the unsuccessful entrance opening attempt. When the regional manager receives an urgent message, he/she would initiate a backup plan to open the entrance of that particular location. The backup plan could be sending another employee to that particular location to repeat the call-in process or with a master key to manually opening the entrance.

The verification process of the present invention could utilize any available methods comprising Video Surveillance, IVR Systems, RFID Tracking, and Manual Tracking as mentioned above. However, no matter which verification process is utilized, it is important the following criteria are met:
Verify that the system is properly installed and configured.
Check that the system has proper authentication mechanisms comprising key cards or biometric data.
Check the system regularly to ensure that it is functioning correctly and that there are no technical issues.
Verify that the system records all access attempts and entry/exit events, and promptly notify supervisors to initiate back-up plans.
Ensure that the access control system is properly integrated with other security systems comprising video surveillance or alarm systems.
Regularly review the access logs and monitor for unauthorized access attempts.
Ensure that the personnel are properly trained to track and record entry/exit events.

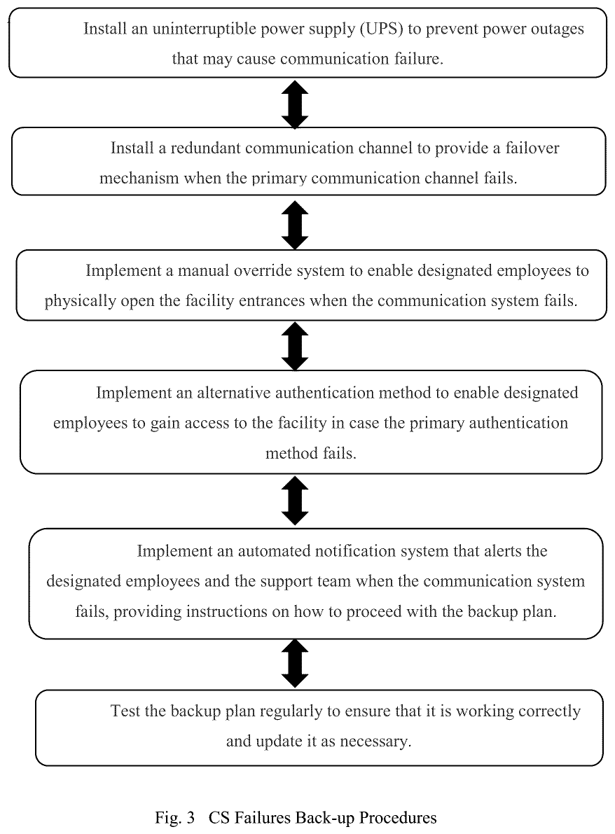

FIG. 3 illustrates a backup plan or procedures when the communication system (CS) to the CMS or IVR failed, the following steps could be taken:
1. Install a backup power supply, such as an uninterruptible power supply (UPS), to prevent power outages that may cause communication failure.
2. Install redundant communication channels, such as cellular data or satellite communication, to provide a failover mechanism when the primary communication channel fails.
3. Implement a manual override system to enable designated employees to physically open the facility entrances when the communication system fails.
4. Implement an alternative authentication method, such as a physical key or a backup access card, to enable designated employees to gain access to the facility in case the primary authentication method fails.
5. Implement an automated notification system that alerts the designated employees and the support team when the communication system fails, providing instructions on how to proceed with the backup plan.
6. Test the backup plan regularly to ensure that it is working correctly and update it as necessary.

By taking these steps, the system can provide uninterrupted service even when communication to the CS or IVR system fails.

The CMS of the present invention can be implemented at much lower cost with the advent of AI and IoT technologies when used synergistically. IoT devices provide the data for AI systems to analyze, learn from, and automate. While IoT focuses on connectivity and automation, AI focuses on analysis, interpretation, and decision-making.

The IoT connects devices to the internet, allowing them to share data with gateways, applications, servers, and cloud platforms. This data is then transmitted versatilely via wired or wireless means comprising cellular networks, Wi-Fi, Bluetooth, satellite, or Ethernet.

At present, cellular connectivity is a popular choice for IoT due to two key reasons:
Global Reach: Cellular networks cover most corners of the globe, making them accessible worldwide.
Standardization: International alignment on technologies comprising 2G, 3G, 4G, 5G, NB-IoT or LTE-M ensuring consistency and reliability.

When the present invention utilizes cellular IoT, all the devices, such as sensors, trackers, or smart devices are connected to a cellular network. The connectivity layer bridges the devices and cloud levels in the IoT technology stack. Sensors on IoT devices measure various parameters in the environment, capturing data. These devices transmit data to cellular gateways, which act as intermediaries. Gateways relay the data to applications, servers, or cloud platforms for processing. The cellular network handles the communication, ensuring seamless connectivity.

Other popular IoT setups involve local processing. IoT gateways or edge devices analyze data either locally or send it to the cloud for further analysis. During local processing, real-time communication occurs among devices, interacting with similar devices based on exchanged information.

The present invention utilizes a dynamic dashboard with a big-screen monitor that shows the current facilities status. The display will have maps that operator could zoom in or zoom out of a facility of interest. It could include news or other information useful to the operator. With the advent of Artificial Intelligence (AI), Big Data (BD), IoT, and Generative AI, the present invention could be easily integrated to provide faster verification or authentication process, and more meaningful data analysis and insights on staffing efficiency and needs. While IVR systems have been used for a long time to automate phone-based customer service, they can be frustrating for customers because of the limited options and clunky voice recognition software. IVR system is also evolving with the development of Artificial Intelligence (AI) and Natural Language Processing (NLP) technology expanding the range of ways that callers can now interact with computers on the phone.

IVR system could be replaced by apps running Amazon Alexa or Google Assistant type of Chatbots using the Generative AI technology. Chatbots, on the other hand, can offer a more seamless and intuitive experience for customers. Chatbots can provide customers with a more personalized and conversational experience, which can lead to higher customer satisfaction rates. Chatbots can also integrate with other digital platforms comprising websites or messaging apps, which can make them more accessible to customers. It will be apparent to those skilled in the art that various modifications and variations can be made to the system and method of the present disclosure without departing from the scope or spirit of the disclosure. It should be perceived that the illustrated embodiments are only preferred examples of describing the invention and should not be taken as limiting the scope of the invention.

1. A Central Management System (CMS) for monitoring facility entrance activities in different remote locations comprising:
a communication system (CS) connects to a Central Interactive Server (CIS);
a Data Storage System (DSS) having whitelists stored;
an Interactive Voice Response (IVR) System, Chatbots and IoTs are linked to said CIS for identity verification and tracking analysis data;
a Task Scheduler (TS) within the CMS for assigning employee tasks;
an Open Door Mechanism (ODM) at said remote locations communicating with said CIS; and
a Visual Dashboard and Notification System (VDNS) for displaying monitoring information.

2. The CMS as claimed in claim 1, further comprising:
an access control system placed at said facility entrance to record the movement of people and vehicles in and out of the facility.

3. The CMS as claimed in claim 1, further comprising:
Radio-Frequency Identification (RFID) tags attached to personnel or vehicles to track their movement in and out of the facility.

4. The CMS as claimed in claim 1, further comprising:
Manual tracking having personnel physically stationed at entrance of said facility to record the movement of people and vehicles in and out of the facility.

5. The CMS as claimed in claim 2, wherein:
said access control system require some form of identification, such as a key card or biometric data, to gain entry and exit.

6. The CMS as claimed in claim 1, wherein:
said IVR system is an app running on Amazon Alexa or Google Assistant, using Generative AI technology.

7. The CMS as claimed in claim 3, wherein
said CIS is for sharing data with gateways, applications, servers, and cloud platforms.

8. The CMS as claimed in claim 7, further comprising:
An Artificial Intelligence (AI) module for data analysis, prediction, interpretation, and decision-making.

9. The CMS as claimed in claim 8, wherein
said CS connects to the internet via said CIS comprising cellular networks, Wi-Fi, Bluetooth, Satellite, or Ethernet.

10. The CMS as claimed in claim 9, wherein
said VDNS is a display comprising desktop PC, laptop, tablet, or Smart Phone.

11. The CMS as claimed in claim 10, wherein
all CMS tracking activities follow applicable privacy and data protection regulations.

12. A Facility Entrance Management method, comprising the steps:
1) Checking the CMS has proper authentication mechanisms, such as key cards or biometric data;
2) Checking access control system in the CMS for technical issues;
3) Verifying all access attempts, and promptly notifying supervisors to initiate a back-up plan if failure detected;
4) Reviewing access logs and recording any unauthorized access attempts; and
5) Ensuring the personnel is properly trained to track and record entry/exit events.

13. The Facility Entrance Management method of claim 12, wherein said back-up plan comprising the steps:
1) Installing an uninterruptible power supply (UPS) to prevent communication failure;
2) Installing redundant communication channels comprising cellular data, wi-fi or satellite;
3) Implementing a manual override system to enable designated employees to physically open the facility entrances;
4) Implementing an automated notification system that alerts the designated employees; and
5) Testing and updating the backup plan regularly to ensure that it is working properly.

14. The Facility Entrance Management method of claim 12, wherein said verifying step further comprising the steps:
1) Receiving location and ID code information from requester through an Interactive Voice Response (IVR) system;
2) Comparing said received information against a stored whitelist;
3) Sending an open door signal and a welcome message to the successfully verified requested location;
4) Sending a notification message to request additional information if unsuccessfully verified;
5) Sending a rejection message after numerous unsuccessful verification attempts;
6) Recording all verification attempts; and
7) Creating entrance activities status reports.
